(19) United States
(12) Patent Application Publication
(10) Pub. No.: US 2026/0260041 A1
(43) Pub. Date: Sep. 3, 2026

(54) PRODUCTS AND PROCESSES USING KEY FRACTAL ELEMENTS

(71) Applicant: Gregory Marcus Friedlander, Mobile, Al USA, AL (US)

(72) Inventor: Gregory Marcus Friedlander, Mobile, Al USA, AL (US)

(21) Appl. No.: 19/474,485

(22) PCT Filed: May 11, 2024
(86) PCT No.: PCT/US24/29009

§ 371 Date: Oct. 10, 2025

Related U.S. Application Data
(63) Continuation-in-part of application No. 18/196,930, filed on May 12, 2023.
(60) Provisional application No. 63/441,856, filed on Jan. 30, 2023.
(60) Provisional application No. 63/451,300, filed on Mar. 10, 2023.
(60) Provisional application No. 63/545,185, filed on Oct. 22, 2023.

(51) Int. Cl. G06F 30/27

(52) U.S. Cl. CPC G06F 30/27

(57) ABSTRACT

The present invention relates to a method for improving processes in various undertakings by employing Key Fractal Elements (KFE). The method involves utilizing KFE to affect change in CT states and interpret matrices of CT states. By applying KFE elements, categorization, prediction, manipulation, and the design of matrices for any process; efficiencies and better understanding of results is obtained. The present invention provides a comprehensive approach to enhancing processes in diverse domains through the utilization of Key Fractal Elements.

### TECHNICAL FIELD

This invention relates to the field of dimensional model usage in all areas of patentability based upon the ability to interpret, categorize, weigh, evaluate, and leverage existing scientific products and processes by redesign based on the underlying fractal features.

### BACKGROUND ART

Examples of related art by the inventor providing background information can be found in Provisional: No. 63/436,647 filed Jan. 2, 2023; 63/441,856 filed Jan. 30, 2023, and Provisional patent 63/451,300 Filed Mar. 10, 2023 and prior filings sited therein. Some of the prior filings may be prior art and help explain some of the math although it has been substantially altered in the priority documents and this patent, noting that no factual or legal representations as to prior art are made for the various countries under which this patent will be examined as the various publication dates are of record.

### SUMMARY OF THE INVENTION

### Technical Problem

Scientific research generates a empirical information without a common framework, making it increasingly difficult for researchers and other users to efficiently access, analyze, and utilize relevant information. Traditional methods often rely on random and unrelated concepts which makes efficiency impossible. While the prior work of the inventor showed much of the fractal framework, details were required showing transitions to create a more complete model.

### Solution to the Problem

One of the primary elements of this patent is the disclosure of the transition from dimensionless fpix solutions in series to circular areas governed by the Basel problem as modified by FIP (fractal information physics, this invention) to a hybrid of circular and MI curvature offset by fractally relevant distances and then on to the overlapping spiral model inherent in neutron bonding including the transition between fpix mandated proton and electron elements and MI (Fibonacci and in particular overlapping F-series) structures and the continuing back and forth of these elements at fractally relevant scaled sizes as all these elements take fractal steps larger or smaller according to 2\hat{ }n and base number series as taught herein. This invention covers the manipulation of all dimensional features based on fractal definitions of information making up the dimensional features as solutions to the iterated equations defining the fractals. This includes combinations of solutions to the iterated equation as described below which can be referred to as compression of the fractals, compression referring to the combinations of solutions to form a matrix of solutions to the iterated equations.

Compressed matrix are larger fractal solutions made up of smaller fractal solutions in the nature of fractals where the iterated equations and resulting fractals are defined by the key fractal elements (KFE). While exemplary drawings are provided, the nature of all dimensional features of the universe as results of KFE means that all things are drawn from this common framework, from force to black holes, so comprehensive drawings are unnecessary since all dimensional features under consideration are defined by the same common KFE.

The Key Fractal Elements (KFE) can be listed generally from the most specific to the least specific: Iterated equation, particularly quantum change, fpix, fuse lengths defined by the values of fpix, 2f(n) where f(n) is either fpix or MI, 2\hat{ }n (exponential compression/decompression), Interactions, including combinations of the more specific KFE, Shifting base numbering as a function of fpix and 2\hat{ }n in the equation 2f(n)\hat{ }(2\hat{ }n) as a exemplary combined iterated equation, ct states defined as stepped fractal compression states or stepped fractal dimensional states and where ct1 states are solutions to fpix, Matrices defined by collections of dimensionally proximal solutions of KFE defining the Matrices, compression as the increasing dimensional proximity if KFE, decompression as the opposite of compression, Force as net compression and decompression at different levels of ct states, time as a form of stop frame animation of quantum change measured at the level of photons (which are compressed ct states) so that changes at and below the level of photon compression can be viewed as pre-time; relativistic effects as the difference between pretime change and time based change, reciprocal sums modeled for compression, base number transitions based on the combination of 2f(n) and 2\hat{ }n; resulting geometries based on the combination of the KFE and resulting angles (e.g. 90%, 45%); balance and fulcrums defined by the resulting geometries.

### Advantageous Effects

The result is a model which can be broadly applied as shown in the claims.

### BRIEF DESCRIPTION OF THE DRAWINGS

FIG. 1 shows proton charting with balance based on fpix and balanced solutions.

FIG. 2 shows how the larger atoms are based.

FIG. 3 shows the fractal effective, relative size of the neutron backbone.

FIG. 4 shows the fractal alignment of fpix circles, curved offset MI and f-series MI spirals including item 112a which is an offset view of item 112 to allow it to be more clearly understood in terms of the process taught.

FIG. 5 shows the internal portion of FIG. 4 expanded so it can be seen to deal with the consequent scale issues presented in drawings.

FIG. 6 shows the stepped transitions as the circular forms defined by fpix start out with the amount of information in the t12 state required to get to a single t15 and this occurs from two directions to form neutrons (pre-atomic fusion) and to bring two neutrons together (atomic fusion).

FIG. 7 shows a representative view of a portion of FIG. 4 to show additional detail of curved MI spirals separated “at the point of closest possible alignment” with offset corresponding curved MI spirals given the tendency to curl together further.

FIG. 8 is a close up of the internal portion of FIG. 7.

FIG. 9 shows a method of using fractal modeling.

FIG. 10 shows an alternate method of using fractal modeling.

FIG. 11 shows a sample application of fractal modeling.

FIG. 12 shows how time and relativistic effects can be represented.

### DESCRIPTION OF EMBODIMENTS

The starting point is an understanding of the set of Key Fractal Elements (KFE) necessary for the full utilization of the invention. The following discussion defines the base logic of KFE which results in matrices of information as compressed or decompressed fpix origin information as defined by the internal logic set out.

Iterated Equations: These are equations that are repeatedly applied to their own output. The specific equations are:

Quantum Change: These were defined as n=n−1 or n=n+1. These equations represent a change in quantity by one unit.

The Fpix Equation: The simple f-series equation, including the iterated equations which make it up, are taught in the prior patents on this subject, the results (1,−3,5,−7,etc) control compression up through the Neutron. Other changes include variations such as 1:1; 1:3:1:5; a base fractal combined to define fractal structures and compression states.

$${f}_{pi} ( x ) = - {1}^{x} + 2 x * - {1}^{x - 1}$$

The resulting value of Pi is also critical to this understanding: Pi(n)=Pi(n−1)+[(x/fpix(n)] where Pi(n−1) for n=1 is the numerator for pi at the level of compression under consideration. So for Pi4, the pi we are used to dealing with, Pi(1)=+4+4/fpix(n) for the first solution and Pi(1)+4/fpix(n) for the second solution. By focusing on a quantum state, fpix; AuT is able to look beyond fractals to the bits which give rise to the universe for the first time. In addition, by understanding the nature of the transitions, new definitions of curvature and the transitions between dimensional curvature based on fpix and different multiples (a*1/fpix(summed over a discrete number of solutions based on the amount of compression of information involved in the greater matrix in which it is examined) a better understanding of force and matter is possible. A as 4 is well recognized, but when we start looking at the relationship of areas and volumes as in the discussion of the Basel Problem within this document, we can see how transitions in either direction evolve allowing improvements in chemistry, electronics and mechanics in all areas as well as bringing these to a single parameter for examination.

Related to this is Two times the base as (2f(n) where f(n) is equal to fpix or MI (below) being the iterated equation in question, give the proton count for noble gases and semiconductors (C and Si) and by electron orbitals.

There are at 2f(n)\hat{ }(2\hat{ }n) finished shifts in geometries, most notably from fpix to MI at Neutron Bonding, including increasing dimensional features between proton and neutron and other finished compression steps, but because of the nature of the equation, 2f(n) forms a base number (if f(n)−2, 2f(n) forms a solution and therefore a base of 4, for example), but because this is raised to 2\hat{ }n, it is stepped (if n=2, 2\hat{ }4 so there are 4 steps).

This is the nature of fractal, gradual compression between finished compression steps, as constrained by the fractal mathematics disclosed.

As a process, this can be applied to atomic structure to define the most stable atomic structures as shown in the process which follows. It has also been shown to allow gravity to be reconciled with other forces and similar benefits in application.

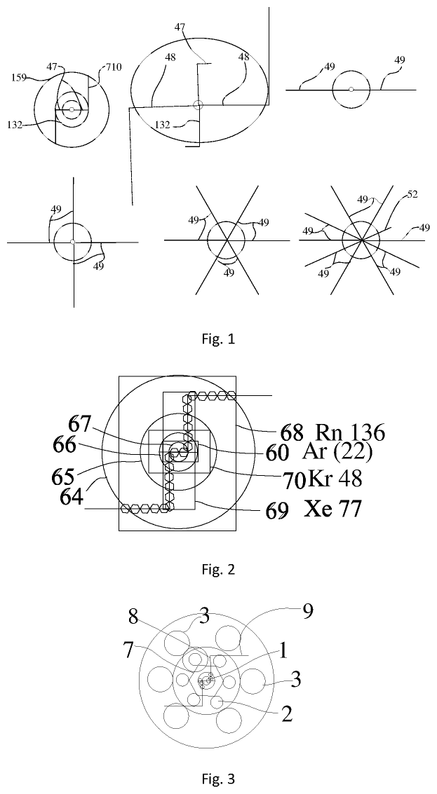

FIG. 1 shows proton charting with balance based on fpix and balanced solutions. The fpix solutions are 1,−3,5,−7,9,−11. These are the only solutions applicable. The 2 inner arms each have a value of 1, then there is the negative value of −3, and for the next arm and so on.

The Fractal origin of Proton and Electron Counts shown graphically based on 2f(x) where f(x)=fpix reflecting the balancing (the factor of 2) critical to the structures defined; 2*1=2, 2*−3=−6, 2*5=10, etc. The “even” results give rise to the noble gases, the “odd” results define the semi-conductors.

Referring to FIG. 1, there are the two balancing hydrogens 47 for a helium atom 132 here identified by the effective radius of the proton core. Also shown are the 3-length negative value arms 710. There are two of these waiting to be filled to give Carbon which area is identified by the potential carbon core radius 159. Next is Neon which has 5-unit balancing arms 48. Items 47 and 132 are shown for reference. Next is Argon where the scale has been changed. The negative value arms −7 are not shown, but the sum (14) would yield the next semiconductor, Silicone. For Argon there are two balanced arms 49 giving the 18 proton total observed. After Argong, there are 4 9 unit arms 49 for Krypton, 6-9 unit arms 49 for Xenon and for Radon there are 9, 9-unit arms plus a broken arm which is 5 unit unbalanced arm 52. While shown this way for clarity, balance suggests that the broken arm and one of the 9 unit arms 49 would each be 7-units and balanced, although different from the 9 unit arms. Each of these 7-unit arms (not shown) might come off of one of the 9 unit arms, by way of example.

The repeating “9's” indicates that the repeating feature of the neutron backbone is the that shown for Argon (2×11=22) as opposed to the balanced “5's” of Neon although radon indicates it might be the balanced 5's with a bridge of 2×1=2 between the two neutron backbones.

Also shown as an example of larger proton balancing is Uranium which is shown with 10 9-unit arms 49 and at the place where the unbalanced arm 52 would have ended there is a helium proton pair 219.

### Electron Charting

Electron “full orbitals” are 2 times the absolute value of fpix (1,−3,5,−7,9). For fpix values of n=1 to 4. This is two times 1, 3, 5, and 7. The electron count (full shell) matches 2×fpix solutions 2*fpix gives full electron orbitals (2,6, 10,14) just like the Proton count for noble gases reflect 2×fpix solutions, skipping the negatives.

The proton counts for noble gases reflect 2 times the positive fpix solutions (namely, 1, 5, 9 for Helium, Neon, and Argon. The next noble gases proton counts are multiples of 9 for Krypton (4×9), Xenon (6 times 9), and Radon (10 times 9, but with 4 less protons showing the importance of the neutron backbone at these scales). These transitions reflect the positive fpix values up to Argon and then build from the negative fpix values. The initial “noble” change is 1 (2 since there are two spirals); then 5 (10); then 9 (18) skipping every other result in the rush towards noble relationships for the proton count. The 3(6) and 7(14) remain relevant as semi-conductors, shells filled to give stabilized repeatable, connectable with efficient electron state exchanges; the 3 in particular as the 6 unit/carbon-like ring structure.

In fractal modeling, there are no electron orbitals as such to fill. Electrons are associated with and balance the protons in an atom. Balanced layouts and the other fractal features may be targeted for fusion, fission, chemistry, electromagnetics. Dissolving this balance between the AuT positron and electron gives rise to ionization. Electron orbitals are discrete due to discrete ct4t12 or ct4t11 information exchange. Lower states being too small to show up being 14\hat{ }100^{th} smaller than the forces we use.

Fpix modeling with N=ct4: If we use f(x) for ct4 is 7, then we have a base 14 compression equation. To get an electron of consequence we can use the ratio of ct4t12:t16 which is 2.6×10\hat{ }−5 meaning the electron is 20.89 ct4t12 states which is robust electron compared to model using 5.4 ct4t12 states (if it were in t13 states it would be 1.5 t13 states). Transitions are base 14 transitions between ct4t12 and ct4t13 and there is no clean transition between 20ct412 states and ct4t13; you already have 1.49 t13 states within the ct4t12 states. Such a “two times” 20.89 ct4t12 unit; ct4t13: 41.78/14=2.98 ct4t13 states.

This may be a balanced 1.48:1:48 product compared to a 1.005:1.005. Much of the information is “massless” because it is in the form of energy equivalent pretime states.

The pair would absorb ct4t11 (or ct4t12) from a source which would give it a charge type exchange (positive or negative).

The ct2:ct5 ratio for gravity to the strong force works well in this scenario.

(1296:1.47×10′=1×10\hat{ }37). If the initial ratio is used, it is 14 or 196:1.47×10\hat{ }40, the 196 number working well). We are working in base 7 or if balance is included, base 14. There are 1.49 T13 states and, multiplying this by 14, there are 20.9 ct4t12 states in base 14 fpix mathematics, 3.84 times as many ct4t12 states as seen with base 10 math.

A pair of electrons under this fpix analysis would be 41.8 ct4t12 states or 3 ct4t13 states less 0.015 lower information states. One might alternatively call it 2 ct4t13 states plus a cloud of almost 1 ct4t13 state's worth of ct4t12 and lower information states. Keeping in mind that this is a base 14 system, this lower information represents 7.03 ct4t12 states.

If we look at what happens if we ignore the 0.4, the shadow of lower CT states around the 5 ct4t12 states, instead of 5.44×10\hat{ }−4¹, it is 5×10\hat{ }−4 and the resulting measurement (0.0005×14) is 0.007. When you average these two results you get 7.30716×10\hat{ }−3 as the electromagnetic effect, an average between the pure ct4t12 and ct4t12 plus lower state effects. This is 99.8657% the same result using the non-fractal morass of equations used to calculate the fine structure constant (FSC). ¹ This is actually 5.438806×10\hat{ }−4 in the calculation and is the measured mass of electron divided by the measured mass of the neutron which is complex because much of the information stabilizing the electrons is considered without mass.

The problem with shifting base numbering is that we have to derive it from observations consistent with the modeling. Full ct4t12 pairing gets a ct4t13 in base 10 may be cleaner than a pair of t13 states, but we also have the evidence of Helium equivalence to paired t13 states. Full shells appear as t13 pairs in the 1.45:1.45 analysis. The evidence includes the resulting similarity of the electron to the fine structure constant and fpix pairing numbers. This is the process of using the fractal design, categorization, and use of features which we have.

The electron viewed as paired T13 states with clouds of ct4t12 (and lower) can find a fractal counterpart in paired neutrons in helium. This is not definitive, but there is support in the modeling.

### Neutron Modeling

New to this line of patents is the determination that at the Neutron, there is a shift dimensionally both in the equation a*1/fpix for curvature and completing the transition from fpix based modeling to MI overlapping spiral models as discussed in more detail below.

The MI overlapping spiral Neutron count as a transition to a base 10 system with folding evolving from a*fpix 2\hat{ }n circles is shown below and has been measured as reflecting inflection points (lengths measured between 2\hat{ }n and spiral arms intersections and spiral arm direction changes).

| | calculated | | | |
|---|---|---|---|---|
| Observed | running | observed | | |
| neutrons | total | protons | Element | fpix |
| 2 | 2 | 2 | He | 1 |
| 6 | 5.499093 | 6 | C | 3 |
| 10 | 9.824209 | 10 | Ne | 5 |
| 14 | 14.12121 | 14 | Si | 7 |
| 22 | 22.79091 | 18 | Ar | 11 |

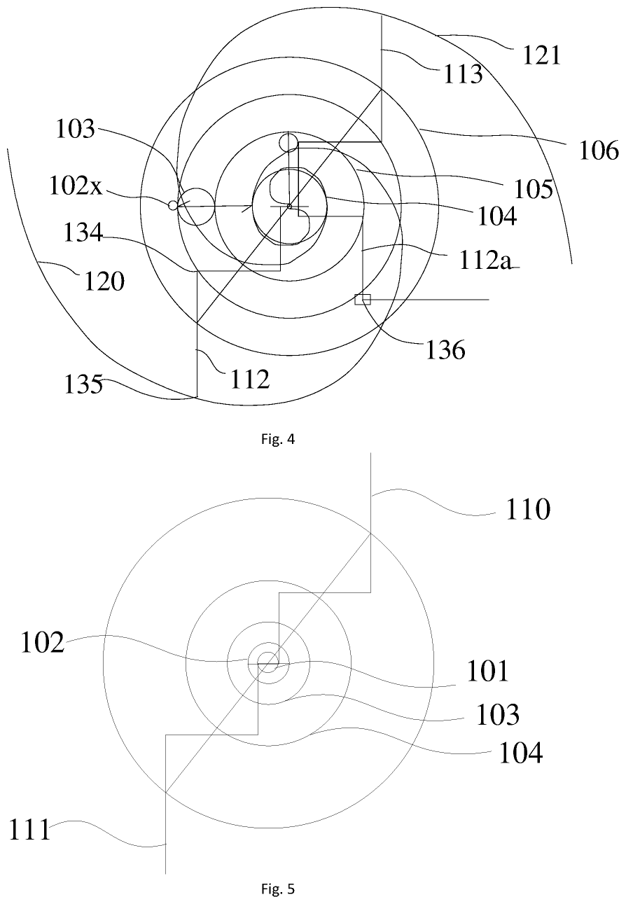

Visible transition from Fpix to MI in the equation 2f(n)\hat{ }(2\hat{ }x) occurs at the proton to neutron fusion location and is visible in atomic and post atomic structures. The inflection points can be seen in FIGS. 4 and 5 and recalculated by treating the initial overlap at item 101 with the value of 1 and using trigonometric functions to calculate inflection points defined by the change in direction of the fseries spirals 110 or 111 or where those fseries spirals overlap with the 2\hat{ }n circles, items 101-104.

The MI overlapping spirals are reflected in the appearance of MI in large structures from atoms to galaxies as shown with the example above right. The model shows shifting base numbering complicating an already complex compression and decompression (folding and unfolding) mechanism.

Fractals give rise to curvature (accepted science, although not with this breakdown of elements) and fractals giving rise to the electron shells as well as proton and neutron counts.

The sums and reciprocals of sums of fpix results are also critical, reflecting the compression of information and curvature.

At the levels where we live, there are at least three choices for f(x) in the equation 2f(x)\hat{ }2\hat{ }x, Fibonacci (1,2,3,5,8,13), fpix (1,3,5,7,9) and the building sum (1,2,5,8,3,2,7,12) which results from the absolute value of “fused” values of fpix over time as shown in FIG. 1. An analysis of observations shows that all of these solutions to f(x) in the iterated equation CTx=f(x)\hat{ }2\hat{ }x evolve and devolve as is the case for this unique fractal, fpix which must itself evolve from and according to the KFE leading to the quantum count.

Exponential Compression: 2\hat{ }n is observed and is important to cause compression and transitions.

Transitions between iterated results are another KFE. The most important one, might well be the transition between Fpix and MI; but dimensional transitions are also important and the section on Basel results shows how this is expressed.

Fibonacci Sequence MI): This is a sequence of numbers where each number is the sum of the two preceding ones, usually starting with 0 and 1. The general form is:

F(n)=F(n−1)+F(n−2) (0,1,2,3,5,8) or the reverse in decompression. This transition occurs at neutron bonding.

The interaction between MI and 2\hat{ }n circles generate the neutron count (ignoring isotopes) for the noble gases and semi-conductors. These can be combined to show both atomic structure:

FIG. 2 shows how the larger atoms are based on a base 5 or 6 unit just as the protons shift to a base 9 unit, about the fulcrum at the center 67. In larger atoms, the Carbon backbone 5.5 to 6 variation can be used to design atoms as hexagonal blocks (of 5.5 to 6 neutrons) of neutrons arranged in unitary blocks up to Argon (22 Neutrons, 18 Protons) and to units of 6 from Argon to Radon. The fractal size reflects the space taken up in MI modeling of the sets of 6. The areas of overlap or area of association are the same as with individual neutrons proportionately.

In this case, in sets of 6, Argon, in box one 60 is 4 sets of 6, Krypton in box 70 is 6 sets of six.

Xenon is the first special, more theoretical case since it is a balanced “14 units” but these appear as all 5.5 units as opposed to 6 units (14*5.5=77) in box 69.

Radon could follow the Xenon pattern appearing as 24 balanced units which appears to be 16 units of 5.5 (88) with 8 units of 6 (48N) shown in box 68.

Observation is that that this second shift, from single unit overlapping MI spirals to 5.5 unit overlapping MI spiral compression occurring at Argon which works in either 6-unit or 5.5-unit form of MI modeling. This pattern appears in other places, for example where the fpix to MI shift occurs where both go from 3 to 5 (−3 to positive 5 in the case of fpix).

In this case, for example, item 4 (a single neutron) Is replaced with item 67 (a 5.5 unit set of neutrons). 2\hat{ }n compression changes is the area in item 66 is 2\hat{ }n times that of item 67 and the radius of item 66 is twice that of item 67. This means that a corresponding inner circle 67 which is of sufficient diameter to hold ⅔ of the first legs of two MI spirals, fourth circle 66 with a diameter twice that of inner circle 66, third circle 65 with a diameter twice that of fourth circle 66, and second circle 64 which is twice the diameter of third circle 65.

Isotopes can change the overall structure; this modeling is to provide a basis for fractal modeling of the most stable form of the atoms.

The problem that arises with the shifting base numbering is that “n” under fpix is 1, −3,5, −7 for the first 4 counts. We use fpix counts up to neutron pairing and then moving to n=5 (MI count of 1,2,3,5,8) which involves several base number changes.

The alternative arrangement of symmetrical blocks works well in terms of modeling, but mathematical observations favor maintaining MI overlapping spirals, visible in large structures from snowflakes to galaxies.

### a Look at Other Large Atoms

Zinc has a paired 2 unit 5.5-unit carbon backbone reflected by the 11 in the drawing. It can be drawn relatively balanced. If we remove one of the protons to form Copper, a gap is introduced, and this can be the source of electron movement as they seek to balance the neutron backbone. This increased pressure on the protons can be theorized to reduce their reliance on the electrons for balance or possibly even encourage a loose cloud of electrons to provide additional information to balance the atom, to fill in the gaps created.

Iron appears to have a 6×6 structure. We can show this balance is about a 5-sided neutron backbone. Non-balanced structures are possible, such as an endcap of 5 and it is possible that there are structural transitions that reflect changing properties, although modeling suggests this is at the molecular and not the atomic level.

A five-sided backbone arrangement for Iron allows for a balanced outer proton core, but there are other structures suggested. The unaligned “c-shaped” structures allow for a gap to allow the passage of information outward from the gap to be replaced by information coming in through the outside. This matches the horseshoe shape of horseshoe magnets which alternatively suggests information jumping the gap. If these gaps are aligned the passage of information is no longer averaged out and you get a magnetic effect. Cobalt and Nickle show this same magnetic property, having similar even neutron bones (plus 2 N), Magnesium interestingly is paramagnetic with its similar, but odd numbered neutron backbone. It is worth noting that smaller paramagnetic materials have different features. FIG. 3 shows the fractal effective, relative size of the neutron backbone composed of neutrons 4 which are viewed for purposes of fractal consistency of relative numbering as ⅓ the size of the protons, a relationship reflected in force exchanges as well as atomic design. Also shown is the transition to MI geometry as the overlapping MI spirals which form the backbone are distinguished from the circular rings of protons 2 and electrons 3. While the sizes of the neutrons and protons are fractally relevant, if not precise, this is not the case for electrons which are relatively small, but which occupy larger areas over time, so this occupied area is shown to give an example of how these small units might balance the protons 2. Modeling suggests that positrons defined as one half of electron pairs extend from the protons 2 and are responsible for their charge and occupy part of the area of the electron 3 and are not separately identified since they remain largely a theoretical fractal element. This shows how the six sided arrangement comes into play which is observed based on the two dimensional nature of the atom.

### Base Transitions

Fractal modeling can be used to model the complex and intricate structures of particles and to predict the behavior of charged particles. Fractal models are useful for modeling systems that are difficult to describe using conventional mathematical techniques because they can reduce complex and irregular shapes and structures found in these systems to fractal components.

Base transitions involve exponential (x\hat{ }n) results, 2\hat{ }n in the case of the transition from ct1 to ct2 (base 1 to base 2). Likely 2\hat{ }n arises from this base number change reflected in the 2 unit difference between solutions to fpix. This raises the possibility that the exponential 2f(n)\hat{ }(2\hat{ }n) equation might look more like 2f(n)\hat{ }x where x varies and the possibility that various exponential 2\hat{ }n, 3\hat{ }n, 5\hat{ }n, etc. might come into play in the mathematical compression equation where n is equal to a number or an equation (like 2\hat{ }n or 3\hat{ }n or some variation of those, including something like (5\hat{ }n3)\hat{ }(3\hat{ }n2)\hat{ }(2\hat{ }n1)). The transitions observed between electrons, protons and neutrons and energy appear as 2\hat{ }n, at least at energy from matter transitions.

Coincidence is often viewed as a random event, something that occurs without any “math,” other than probability which is inapplicable at a quantum level. Everything that happens is a result of a cause-and-effect chain, originating dimensionally in a series of solutions to the equation fpix changing based on n=n+1. The idea of coincidence is a human construct, an attempt to explain hidden patterns. AuT sets out the patterns, patterns not hidden, their significance overlooked.

Pre-ct4t11 changes are the pretime, stop frame animation changes that create the dimensional effect we call time. Note that acceleration does not create relativistic effects at the quantum level because (1) there is no time and (2) all changes occur in ct1 states at the same rate, although staggered by fuse length.

Shifting base numbering: These are changes that follow an exponential function. The general form is: X\hat{ }y\hat{ }z especially when expressed as 2f(n)\hat{ }(2\hat{ }n) where f(n) reflects the base numbering in question and 2\hat{ }n the number of steps of compression within the f(n) base numbering.

CT states defined as stepped fractal dimensional states from iterated equations defined by fractal compression or decompression due to compression of lower CT states along KFE rules of compression.

Force defined as the result of net winding or unwinding of CT states as viewed from post-time CT state perspectives including ct4t11 pretime changes viewed as energy.

Time is defined as stop-frame animation resulting from changes in pretime CT states defined as CT states at and below the level generating electromagnetic effects. Relativistic effects as the difference between pretime and time-based change.

Reciprocal Sums, inversions (1/x) of iterated equations: This suggests the application of the mathematical operation of inversion (taking the reciprocal) to the elements of CT state matrices. Fractal structures based on iterated equations/

Base and exponential transitions governing matrix composition and interaction, including spatial, energy, atomic, chemical, electrical, biological, and large structures, absorption and spew control, and fractal proximity of states.

Resulting Dimensional variations compression or decompression of CT states and the resulting formation of matrices of CT states. Curvature defined by a solution to fpix for pi with definitive limitations generating the sequential amounts of dimension and curvature in response to net CT state compression.

Above is the amount of compression from electron components to Neutrons from one of two sides along with the associated dimensional transition.

Dimensional variations start in multiple versions of two dimensions before arising at the one that we are familiar with based on pir\hat{ }2 as derived using fpix and fractal transitions. At lower and higher dimensions these fractal qualities are maintained according to the equations set out that give rise to them, primarily starting with fpix and determinations of prediction and manipulation using KFE.

### The Basel Problem Vs Fpix:

### Sum(1toinfin)1/n\hat{ }2=pi\hat{ }2/[6=4+sum(1toinfin)[4/fpix(n)]]\hat{ }2/6

6*sum(1toinfin)1/n\hat{ }2=[sum(1toinfin)4/fpixn]\hat{ }2=[sum(1toinfin)[4/[−1\hat{ }n+(2n(−1)\hat{ }(n−1)]]]\hat{ }2² Note that n\hat{ }2 can never be negative and this means that the alternating value of fpix is irrelevant to closing in on pi but is instead a function of the steady increase in value of the denominator, the smaller reciprocal stepped evenly yields pi. ² Note that while infinity can be used here, it actually is a large number, but not infinity.

The negative values of fpix approach the values of 1/n\hat{ }2 faster, but not exponentially faster. The Basel ratio: If one eliminates the factor of 6, the corollary is that the ratio of the Basel sum (1/n\hat{ }2) to the sum of pi\hat{ }2 approaches 6, is 6 at infinity. It is not a surprise that the square root of the Basel sum to the square root of the pi sum approaches the square root of 6, approximately 2.4495, but it is an irrational number, like pi. These numbers, which cannot by definition approach a specific solution, do not go on forever because compression limits the number of solutions relevant.

The relationship between the square root of an infinite sum of 1/n\hat{ }2 to a sum of 1/fpix\hat{ }2 is the square root of 6 (sqr(6)). The reciprocal relationship is that the relationship of the infinite sums of n\hat{ }2 to the sums of fpix is 0.4082 approximately.

As in other cases, we need to adapt the nomenclature for the new mathematics. We use Pi(4) for pi based on a numerator of 4 applied (as shown below) to fpix. Pi(B) or Pi(4/sqr(6)) [sqr(x) used for the square root of x) for the curvature solution at the Basel problem solution.

More specifically, the solution to the Basel problem is, for any number of points, being at least two, the last two points averaged based on Basel(x series)=[pi[4/sqr(6)]]\hat{ }2 as shown below where this is pi calculated using fpix in the manner shown herein where n=4/sqr(6) which is approximately equal to 1.633, the reciprocal being 0.61237.

Note that if pi were based on the numerator of 4 (instead of 4/sqr(6)) the second to last column to the right would approach 6 instead of 1 (equality).

Above is an initial plot of the Pi\hat{ }2 in question/B and the average of the two-solution approaching 1 from x>1.

Basel and the origin of dimensional change: r\hat{ }3 for 3 dimensions; r\hat{ }2 for 2 dimensions Under this analysis the equation PiR\hat{ }2 becomes R when pi is based on the Basel equivalence of Pi(4/sqr(6)). That is when pi is calculated using (4/sqr(6) as the numerator and fpix for the denominator summed over the appropriate number of solutions) reflecting an inflection point in dimensional building as at this point pi(4/sqr(6)) for an infinite number of points=R. Since 6 is an irrational number, the answer short of infinity is on either side of the solution and never precise, ignoring infinities which do not exist under FIP mathematics. This means that at one point pi(4/sqr(6)>R and immediately beyond that in terms of curvature based on evolving numerators of pi pi(4/sqr(6)<R.

This inflection point means many things. It can be used, for example, in computer processing design and function since it is an inflection point observable as the origin of dimensional change from two to three dimensions.

A Look Beyond the Basel Problem³ ³ Euler became famous in the 1700s for solving the Basel problem. It might be better to say using fpix in place of pi provides a different solution, rather than a better one; but it provides different insights.

What we have available are the following: 1, 3,5,7; 2,6,10,14;2,4,8,16 before we reach MI these being fpix solutions, 2fpix and 2\hat{ }n compression number. Since we have a solution for pi(B), we can draw some inferences for other measures of curvature at unobserved levels. We have two points of reference, possibly 3 depending on how far you want to take this. These are summarized below in context.

Basel solutions suggest some for of exponential increase, likely the numerator from the prior equation squared, divided by the square root of n*3 times fpix the radius in question raised to the number of dimensions.

So f(x)=[f(x−1)\hat{ }2/sqr(3*x)]*r\hat{ }x times 1/sum(fpix) where fpix is summed over the number of solutions determined appropriate (usually assumed as infinity in pre-aut math, but here it is a function of the amount of compression involved.

We have (to calculate curvature using fpix) 2\hat{ }2 or pi(4/sqr(6)) for 1/n\hat{ }2 and we have 16/3 or (4\hat{ }2) or (2\hat{ }4)/sqr(9) for fpix with 4/3 pi r\hat{ }3 (more specifically (4*4/(fpix*3) defining the resulting sphere.

When moving from 3 to 4 dimensions there are choices. In this case, the most likely choices (this is not observed as directly) you get to 2\hat{ }6 or 2\hat{ }8 divided by sqr(12) or sqr(3\hat{ }3) for four dimensional change with fpix [pi(2\hat{ }6/sqr12);pi(2\hat{ }6/sqr(27); pi(2\hat{ }8/sqr(12));pi(2\hat{ }8/sqr(27)). In all of these cases pi is calculated the same way summing for the equation which yields pi for 4, expressed here as pi(x)=x+sum(nfrom 1 to y)(1/fpix(n) [noting that at pi(4) y is a very large number based on the number of ct1 states necessary to get to the level of compression shown, but not infinity.

KFE includes fractal difference in dimension which are themselves a fractal result of compression but not a straight path due to exponential mathematics.

Because of how dimensional transitions occur, in addition to the features suggested by the Basel problem, KFE includes fseries (fpix solutions in a series), fseries and Mi spirals, fractally offset (by f-series mandated dimensions) and overlapping spirals and exponential (2\hat{ }n, shown as 2*r for circles) defining separation and compression features.

Compression features which result from the relationship of KFE are KFE.

KFE includes the changing vs stable pretime features, time, pretime features; the nature of pretime change vs time-based change, the relative amount of pretime change vs non change in a matrix as well as changes associated over changes in the quantum count, or a combination of those features.

Fractal Matrix: KFE includes the system of organizing ct states into “fractal matrix” containing elements like space, time, force, etc., represented as fractal features. KFE includes the fractal design of ct states, shown clearly in atoms including the Neutron backbone and the structure of resulting proton cores and electron clouds as pathways to increase and control the release of energy. This involves the KFE elements and their interplay, the relationship of fpix and MI and the compression steps reflected in getting atomic and molecular structure to where it is. KFE includes the type of absorption and spew, sharing within matrices which changes with the fuse length, itself a KFE.

KFE includes the type of molecules created, the dimensionally expansive or contractive features and the orientation of atoms created, the order of creation, and the orientation (especially spiral alignment, pretime change characteristics and net pretime change characteristics) of atoms and other ct states in a matrix at all stages of the reaction. These matrices are collections of smaller fractal features, so everything except for individual ct1 states or the components of ct1 states to be even more narrow.

Since they are all fractal transitions, the Transitions between MI and FPIX and dimensional compression (combinations moving into more dimensions); Contact/collision as ct state exchange or sharing, compression as allowing perceiving information as combined. Collisions as the exchange of information between at least two AuT matrices and post-collision effects reflecting the net change of CT state and pretime change in each resulting matrix of the at least two matrices. These occur along MI and F-series spirals and 2\hat{ }n compression or decompression of CT states in and out of alignment; this is absorption and spew which can be viewed as different types of information sharing between matrices.

AuT allows for time to be taken out of the equation and for focus to be totally on fractal transitions in matrices of ct states and quantum change and fuse lengths reflecting the amount of change within a matrix without any time elements being required eliminating the discrepancies otherwise present when time is used.

CT states, fpix equations, fuse length, MI, defined spirals, overlapping and exponential compression features, pretime change characteristics, spiral alignment, CT state sharing, collisions as information exchange, net compression/decompression, balance and imbalance, changing base numbering, and net pretime change characteristics.

KFE includes interactions and transitions between equations and solutions to these which result from sums and inversions of sums of these KFE.

The result of the KFE fractal structures based on iterated equations, including quantum changes based on quantum changes based on fpix, inversions of sums of fpix and the Fibonacci sequence and sums of MI. Just as inversions of fpix reflect compression so can the same be true of MI.

Fractal Matrix Construction: KFE involves treating elements like space, time, force, energy, matter as parts of a fractal matrix and force and energy as changes in those matrices including the consequent exchanges of information. KFE includes the fractal design of matrices using time as CT state dimensional change, energy as CT state change, the Neutron backbone, proton cores and electron clouds as pathways to chemistry, to increase and control the release of energy, redirection or absorption of the energy. This includes fractally relevant shapes such as six or 14 sided structures representing atomic inflection points and pre-atomic, proton inflection points respectively.

KFE includes KFE expansive or contractive features and the orientation of atomic or molecular matrices created, the order of creation, and orientation based on KFE in matrices at all stages of reactions as CT state change.

CT States: CT states represent different levels of compression and form the building blocks of the fractal matrix. KFE includes CT states, fpix as an equation and as the building block of ct state features: fuse length for individual solutions to fpix as well as for matrices of solutions and compression states, fpix matrix-based MI solutions, Fpix and MI defined spirals, including where they overlap or separate along fractal line.

KFE includes Exponential compression features, particularly as functions of fpix and MI, changing vs stable pretime features, the nature of pretime change vs time-based change, the relative amount of pretime change vs non change in a matrix, changes in the quantum count, KFE spiral alignment, pretime change CT state changes, CT state sharing and the related concept of collisions as information exchange, net compression/decompression of CT states and matrices and the related force or energy features, balance and imbalance, changing base numbering reflected in CT states and dimensions, and net pretime change characteristics or a combination of those features. KFE can be used in field modeling and mechanical interactions. KFE “engines” focus absorption or spew of ct state exchanges which otherwise likely burst from the surface of atoms like volcanic eruptions from volcanos and solar flares from the sun.

Resulting geometries and Balance: A balanced state is vital in KFE compression, observed in atomic and molecular structures and interactions between CT states. Balance is a key aspect of KFE, observed in atomic and molecular structure about the lower ct state or plasma fulcrum, balance about fulcrums, Overlap is seen to vary as it moves towards curvature at different compression levels.

Inherent to these is the fractal form in balance (the linear spirals), plasma centers between CT states, and net absorption leading to the folding. A fulcrum of lower states about which higher states balance, fractal alignment on either side of the fulcrum occurs because higher CT states form within shells of folding lower states. Balance and folding around the fulcrum are by absorption and spew between the neutrons and then between the protons and neutrons and then between the electrons and protons. This fulcrum of lower CT states continues, including the effects of magnetic repulsion and their corresponding effects of high- and low-pressure system interactions.

Fulcrum Shifting: One of the KFE is shifting matrices about fulcrums from overlap to “fractally stepped” expansion and back. This involves increasing f-series spirals as well as the fulcrum about which they are separated. It also involves the collapse of the fulcrum to overlap of the spirals (not necessarily complete, but effectively complete to add dimension). Fractal spacing, shaping and compression stages and according to the key formulas. Shifting according to fractal observations (e.g. chemistry to sets of 6 and stepped transitions to get intersecting lines as by Mix2 intersecting 2 times 2\hat{ }n circles and the consequent association between MI compression and 1/fpix defined 2\hat{ }n circles.

FIG. 4 and FIG. 5 should be viewed together as FIG. 5 is the central part of FIG. 4 as shown by the common element 104.

What this shows is the circular structures defined by fpix evolving into circles (and ultimately spheres) as taught by solving the Basel problem with fpix, noting that two dimensional structures from a one-dimensional string of non-dimensional solutions to fpix occurs first. The base circle 101 used for this analysis is the overlap of the two overlapping spirals 110 and 111. If one were working with Neutrons, this base circle would be twice the diameter of a Neutron.

The primary circles shown are 2\hat{ }n which means doubling the diameter of the base circle 101 as follows. The second circle 102 is twice the diameter of base circle 101, the third circle 103 is twice the diameter of the second circle 102, and so on for the fourth circle 104, the fifth circle 105, and the sixth circle 106.

Another set of F-series spirals, top spiral 112, rotated top spiral 112a and bottom spiral 113 are offset by a distance equal to fifth circle 103. To understand why this offset is important you have to look at this in conjunction with dimensional characteristics of the universe, the Vitruvian man or a spiral galaxy, for example. Beginning with DaVinci's Vitruvian man, for example, the inflection point 136 corresponds to the circle diameter of the “squared circle” in the drawing, the tips of the fingers of the figure. Another way to get to this is shown at 102x which corresponds to the second circle and a circle 3 times the size of fourth circle 104 and which intersects with the inflection point 134 of spiral 112 which also reaches the circle at the tips of the figure's fingertips in the drawing. The relationships are shown to show how they can be targeted to break things into their fractal components and manipulated by targeting these fractal relationships instead of the less specific concepts (such as chemical and force features which are not derived from fractal information physics taught in this method).

Turning to the galactic form, one sees the two offset curved MI Spirals top C-MI spiral 121 (it starts at the top of the offset defined by the base circle 101) and bottom c-MI spiral 120. These spirals, curved spiral C-MI spiral 120 and curved spiral C-MI 121, match the spirals of a spiral galaxy, but unlike the f-series spirals (overlapping f-series spirals 110, 111 and offset f-series spirals 112 and 113) these have some of the features of the circles, curvature and offset. Note that there is common dimension at fourth circle 104 with the C-MI spirals and they are tied mathematically to the base circle 101 diameter as is shown both by the separation and, as shown shortly, size.

This is to show compression and fpix to MI transitions and fulcrum shifting and well as fractal changes in f-series spirals since the location of relevant inflection points for the f-series spirals match the location of the c-mi spirals when offset by fractally relevant sizes. One of the key elements of this invention has to do with how compression occurs. Here it can be seen that before there is fractal overlap (or after it) there is separation of the spiral elements. This shows the process of transitioning between fpix and MI and how the fulcrums come into existence, the fulcrums represented by the base circle 101 in this drawing and by, for example paired neutrons within a base circle 101 in other embodiments. The fulcrums serve to provide balance for the resulting structures built on them to the extent they are balanced to form higher fractal compression states. As the size of the linear spirals increases, the spacing necessary to get common positions based on increasing fractal sizes.

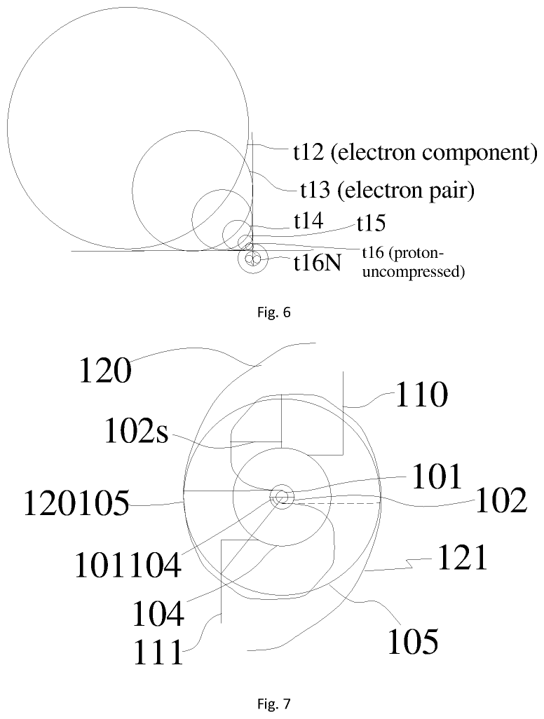

FIG. 6 shows the stepped transitions as the circular forms defined by fpix start out with the amount of information in the t12 state required to get to a single t15 and this occurs from two directions to form neutrons (pre-atomic fusion) and to bring two neutrons together (atomic fusion). In this case t14 corresponds in size to item 101, t14 item 102, t13 item 103 and t14 item 104. The t15 state is twice the size of the t16 which is the size of the proton and neutron, but when it drops into the overlapping form it has stretched into another dimension. While the modeling is exemplary, the t12 state as an electron component, essentially a pair of photonic elements, is also indicated in the pairing of electron and positron components between atoms, keeping in mind that a great deal of information is lost in the process of breaking up the proton-electron bond.

In fusion what you have is item t12 being 2 times the diameter of t13, t13 being two times the diameter of t14 and so on to t16. T16 is the size of a neutron and essentially the size of the proton reflecting the amount of information of the next higher state t15 being 10 times (in base 10) the number of neutrons, i.e. in base 10 there would be 10t15 states for each t16 neutron and 10t14 states for each t15 states and so-on. In fusion you not only need to model the compression in the fashion shown, but at the end you have to collapse the proton into three dimensions (see the Basel discussion to see how this occurs mathematically) but you also have to take the neutrons from the two directions represented by 102s and 102sa in the next drawing, to get a balanced pair.

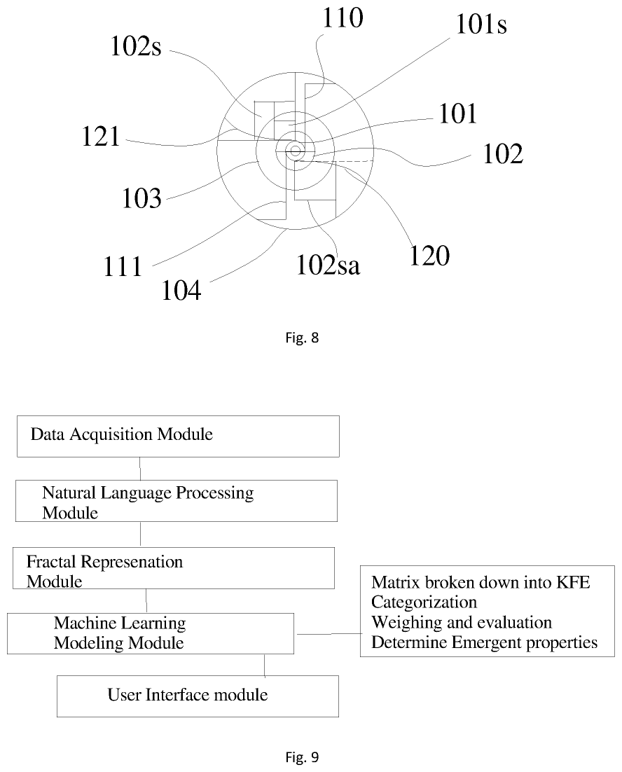

FIG. 7 and FIG. 8 should be read together as FIG. 8 is the internal part of FIG. 7 as shown by the common feature of the fourth spiral 104. This shows how this transition occurs with all of the features included from FIGS. 4 and 5 along with the smaller portions of item 120 and item 121.

For perspective 102s in FIG. 7 is represented by the top of 102s shown as a square 102s in FIG. 8. There is a corresponding square 012sa offset from square 102s. Within 102s (an identical feature in 102sa is not included to prevent overcrowding the drawing) is square 101s. 102s and 101s reflect where the spiral 121 curls on top of the offset 101. Curved MI fractals are similar to those in the prior art, what makes these different are several things, one being the unitary offset reflected by item 101, another being the relationship with the 2\hat{ }n compression, yet another being the relationship with overlapping f-series spirals and the offset reflecting the fulcrum and balance about base circle 101. The relationship of the closing of the curved spirals is areas reflected by 102 sized squares (the diameter of item 102 matching the side length) and the next smaller fractal reflected by the 101 sized square matching the separation equal to the diameter of 101 which is double the length (2\hat{ }n in terms of area difference) of the diameter of the resulting neutrons during fusion. Hence any fusion reaction can be evaluated and fixed in terms of efficient function by modeling these parameters.

These changes in matrices, including expansion and contraction of overlap represent energy transitions at pre-time levels and the transitions between matter and energy are reflected in these (understanding that force is the change between matrices as information in the form of ct states changes the net compression of the matrices) and so this is not only critical in reactions and energy usage (fuels, fusion, heat exchange, etc.) but also in electronics, particularly as electromagnetics interact with matter; but also in things like explosions/collisions and shielding. Because KFE as base logic applies to everything, anything can be modified or designed to improve the matrices at the beginning, midpoints and end using KFE as the base logic and the only limit is the limit of how far into the process KFE is applied and how many of the ct states making up the matrices involved and how many of their interactions or how many quantum steps (as opposed to time) are used and how much quantum change leading to the quantum steps is averaged.

### II. KFE Applications

Application of KFE is using KFE to affect change in CT states, interpret or categorize matrices of CT states. The process is applying KFE elements for categorization, prediction and manipulation and to design radiation matrices for electronics, solar, thermal, fusion and radioactive energy use, capture and dispersal; KFE used to modify frequency-based systems increasing the efficiency of those systems for generation of energy, transmission of energy, use of energy and storage of energy as well as increasing the overall accuracy of results. Field modeling, mechanical interactions, and energy conversion systems (generation, storage, transmission, use). Staged fuels, Electrons and magnets as controlling pretime change fractal states and carrying lower fractal states in higher as part of sharing. Design of matrices, molecular structures, dimensional variations.

General Application: Utilizing KFE to bring about changes in CT states, interpreting and categorizing matrices of CT states. The process entails employing KFE elements for categorization, prediction, manipulation, designing fusion, fission, radiation matrices, frequency-based systems, chemical and biological system. The process entails employing KFE elements for categorization, prediction, manipulation, designing fractally relevant matrices, and enhancing the efficiency of non-fractal systems by adapting them to take advantage of the underlying fractal transitions.

In terms of FIG. 9, the first step in the process is to acquire information related to the subject at hand which need only be the process, product or article of manufacture in question, but should also include related information.
1. Data Acquisition Module: This module gathers and pre-processes scientific literature from various sources, including databases, publications, and repositories. The pre-processing may involve cleaning, formatting, and extracting relevant information like text, citations, and metadata.
2. Natural Language Processing (NLP) Module: This module utilizes NLP (and fractal modeling) techniques to understand the meaning and context of the acquired literature. This may involve tasks like sentiment analysis, topic identification, entity recognition, and relationship extraction between concepts and studies. It is possible to allow this to be translated using a natural language processing module.
3. Fractal Representation Module: This module utilizes the processed text and metadata from the NLP module to create a fractal representation of the scientific literature. This representation may involve:
   a. Identifying key concepts, entities, and relationships within the literature.
   b. Mapping these elements onto a fractal structure, reflecting inherent hierarchical relationships and self-similarity within scientific knowledge domains.
   c. This next step is breaking the matrices and processes inherent in them, down in to fractal elements of matrices associated along fractal lines.
4. Machine Learning Modeling Module: This module builds and trains ML models using the combined information from the NLP and Fractal Representation modules. The models can be designed for functionalities similar to the previous claim, but with the added benefit of leveraging the fractal representation:
   a. Enhanced Categorization: Classifying literature based on both content and structural relationships within the fractal knowledge map.
   b. Improved Weighting and Evaluation: Assigning scores to studies based on relevance, credibility, novelty, methodological rigor, and their position within the fractal structure (e.g., highly interconnected concepts in central nodes may hold greater weight).
   c. Discovery of Emergent Properties: Identifying novel insights and unexpected connections between studies by analyzing the fractal representation for patterns not readily apparent in traditional analysis.
   d. This machine learning modeling module breaks the entire matrix of the several matrices involved broken down into KFE which are then categorized, weighed, evaluated in terms of position, interaction and in the other features of KFE.
5. User Interface Module: (Same function as before, but now presenting results that leverage the fractal knowledge map)
   a. The user interface module will deliver the information. In terms of the resulting ct1 based Information in matrix form it can be subject to: storage, categorization, interpretation, validation and as a basis for design and prediction as part of the interface with the user. This also includes base transitions governing matrix composition and interaction, including spatial, energy, atomic, chemical, electrical, biological, and large structures, in terms of key fractal elements.

While Artificial intelligence is a mode of utilizing the invention, it need not rely on anything other than the processes taught in this patent.

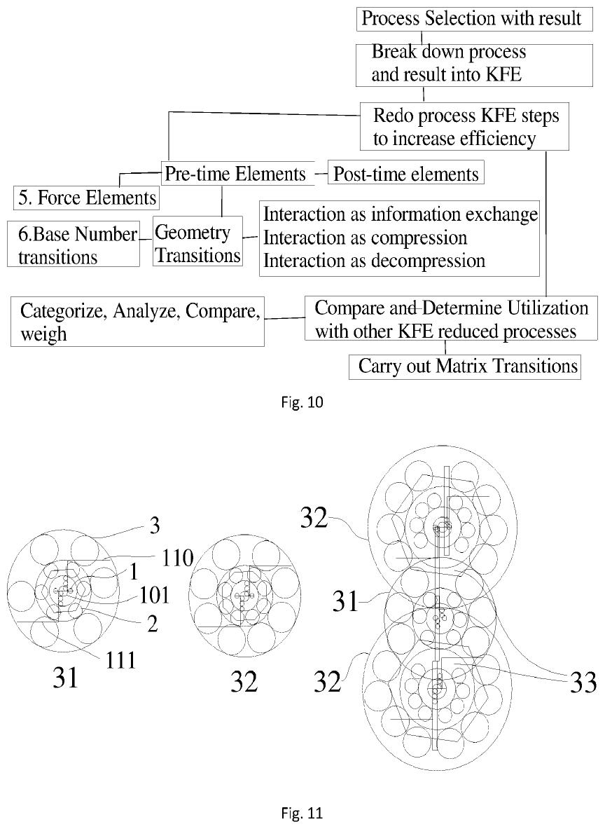

The process may involve a product or article of manufacture. FIG. 10 shows how this would operate. Step 1: A process is selected based on a need or research interest. The result desired is provided or made utilizing the process selected.
Step 2: The process is broken down into KFE as well as the result so that the transitions from one to the other may be determined using KFE.
Step 3: The process is then done or redone based on KFE steps to increase efficiency. As shown this includes breaking the process into force elements (changing matrix features at different levels of ct state compression), Pretime elements (energy, relativistic effects), post time elements which involve more dense matrices, the different base number solutions at the different levels of compression, the different geometries at work, and the exchange of information between matrices and the resulting matrices.
Step 4: The results are then compared to the alternatives and other potential information concerning related methodologies applicable to the process and result which are categorized, analyzed and weighed and then the matrix transitions are carried out in the manner suggested by the KFE to get to the matrices desired as an end point.

This invention involves dealing with empirical methods, but it includes modifying elements desired to conform to Fractal requirements by using KFE as the base logic. It involves Rebuilding elements and applying fractal modeling of their operation which includes influencing the design of machines and reactions.

### V. KFE in Action

Reacting Chemicals: Reacting chemicals using KFE enhances matrix changes, maximizes the release of pretime informational change, and optimizes the use of energy.

KFE Engines: The concept of KFE engines focuses on channeling the absorption and emission of CT states for specific purposes.

Using KFE steps to Stage fuel reactions makes them more efficient. Maximizing pretime change is a concept not even present in prior art.

### VI. Information and Prediction

The process is one of Defining a plurality of CT states representing different levels of compression.

Utilizing KFE concepts to design manipulation of the CT states within the fractal matrix. The method may be used as Controlling absorption and emission of energy within the CT state matrix; for energy generation and transmission, storage and use; to categorize matrices of CT states, weigh matrices and use them. It can involve information Handling: the storage, categorization, interpretation, validation, and prediction of information.

### Applicability to Chemistry and Biology

FIG. 11 shows a simple example of fractal modeling of chemistry.

While only showing the before and after of the large single atom elements, this can be extended to include all elements and reactions can be modeled based on the fractal scales along with solvents, energy and the like using fpix based modeling of all of the elements, even though largely restricted here to the protons and neutrons.

Areas where information is released 33 when carbon 31 and oxygen 32 are combined show where with isotopes the carbon features remain predominant (although less stable or balanced) since the bonding at pre-fusion levels occurs at protons. The heat allows the transition of evenly distributed protons to shift to compressed protons providing space for bonding and this can be copied for fusion at earlier compression levels, the neutron backbones need to be aligned and this is necessary, and presumably easier, by following similar alignment for electrons and proton based positrons (electron units extending from protons to share information with electrons).

Ways to do this are shown with various dimensional change arranged to push the elements together in the order and scales required by transitions in dimension and base numbering required by the iterated equations defining the key fractal elements.

This release of information can be modeled with all the elements of a matrix, it is already shown that information content does not remain constant and that pre-time information is released in exothermic reactions and incorporated in endothermic reactions; but now we can model it as balanced fractal states with particular dimensional characteristics. While showing two atoms of a large solution is a very simple example, the spaces being filled in the manner shown so that the information within those spaces is released, this can be applied to any level of complexity as the KFE remain the same for any transitions of dimensional characteristics.

As was shown above, this allows reconciliation of gravity with the strong force. Likewise, wave particle duality comes from particles being at different pre-time locations when viewed from the position of time. The more pretime changes within these particles, the more places they appear to be and the shorter the wavelength and the more energy they can contribute. Waves reflect pre-time change or pre-time location of ct4t11 states viewed from the standpoint of higher dimensional features. A single photon has more “energy” associated with more “pre-time change” which results in a shorter apparent wavelength when viewed from the perspective of time. A maximum “frequency” of 10\hat{ }24 changes per second is suggested by the Electromagnetic force at the proton-electron interface (T11=10\hat{ }11 ct3 states. 10\hat{ }12*10≥=10\hat{ }36). This is consistent with the scale of forces. This is also consistent with maximum frequency change (approximately 10\hat{ }24) observed in gamma rays.

Net change rates for fpix solutions, slower at the center of the universe, faster at the edges, but electrons moving through the universe reflect the underlying winding and unwinding of the even lower compression states in which the flow of electrons takes place.

### Electro-Mechanical Ellipses

Electricity is not a different state of information except in fractal terms. The same can be said of magnetism. These are not defined pre-FIP so they will be addressed here.

To understand observed distortions, it is helpful to remember that a circle is just a special case of an ellipse where the x and y axis are the same. This is not the case for EM even though they are fractal equivalence, but the relationship is the result of the expansion of the center so that they represent the net of multiple circles distorted by the expanded center (leading to two edges) and this can be seen by application of the overlapping spiral model to either side of the EM expanded center, in the case below a magnet.

A high-end overview shows how electricity and magnetism interact.

### Electro-Magnetism

Energy begins with magnetism. Electromagnetism represents a fundamental force that governs interactions between particles and plays a crucial role in the dynamics of our physical world. Past explanations are at best confusing, at worst misleading, containing fragments of accuracy, the truth hidden like so much else behind the barrier of time and our reliance on electromagnetic signals.

Magnetic repulsion, a manifestation of electromagnetism, can be understood as high- and low-pressure type interactions based on the net appearance of pretime states (ct4t11) circulating around ct4t12 electrons from the perspective of post time. The otherwise slow, fractal equivalent of a low-pressure hurricane hitting a high- or low-pressure system (combining with the latter to form a worse storm) was previously hidden since all we see is the net effect.

Since this net effect includes the introduction of pretime ct4t11 states into the matrix around the magnet, we can “energize” electrons by increasing the concentration of ct4t11 states with more pretime change if we accelerate the magnets carrying those ct4t11 states.

### Combining the Elements of Electromagnetism.

FIP science allows a method to “Channel” this effect to maximize movement of the electrical field or to increase the storage within the metal matrix. While spinning a magnet to get electricity or spinning electricity to get a magnet is well known, targeting the movement of the ct4t11 and 12 states is not known as the concept of using these could not have predated knowing they exist and their relative interaction as the less compressed states coming off and coming back to the more compressed as absorption and spew.

This “field,” a fractal matrix of pretime states, can energize a free wire that is put in a position to pull absorb a portion of the M+ states (as well as the t12 states) which disrupt the t13 states (in the wire this would largely be positrons sticking out from proton cores and electrons) energizing the resulting free t12 and e− states so they move down the wire. Presumably from this drawing, they do not move back readily because of the larger t12 states entering the wire from the other end.

Based on this modeling, the more you can concentrate magnetic fields on electrical flow at the right location, where the maximum ct4t11 states and particularly the maximum M+ are pushed onto the conductors, the more energy extractable at the location. Likewise, the more e− that is present in the wire, the more effective the M+ mix is.

### The Fractal Elements of Electromagnetism: Assuming t13.

The positron-electron pair is where the metal atoms positron is adhering to free electrons or capable of that connection giving the positive effect where the negative effect is the t12 “solution” dissolving those bonds and freeing bondable electrons or half ct4t13 states. The circles represent the closed/even exponent embodiments. Electrons are an example of a hybrid, a one half ct13 open state from ct4t12 closed states.

FIG. 23 shows the portion of this unwinding and winding process which is tied to electromagnetism, the electron is 5.4 t12 states or one half of a t13. The circles represent the even (closed) form of exponential compression, those without circles represent the open forms of exponential compression. While the overlap is not required for the exponential results shown, they are suggested just as the collapse associated with closed form into a circular shape is suggested.

The post time elliptical occupation of M+(the theoretical 5×ct4t11 magnetic equivalent of the 5.4×ct4t12 electron) is shown relative to the electron elliptical area and this pretime movement is what gives it the energy and force we use, the M+, having more pre-time change on average, occupies more places than the electron at any point in time but is exponentially smaller.

While the size of the smaller ct states is exponentially less, the number is exponentially greater and on average more pretime change and space is defined by these ct4t11 states over any measurable period of time. The transfer of this pretime change to the ct4t12 matrix makes the ct4t12 matrix more volatile and more energetic.

### The Non-Mystery of Magnetic Repulsion.

Part of understanding KFE as base logic shown here is the redefinition of energy, time and force. Repulsive magnetic fields are when the buildup of free M+ increase relative to T12 states and attractive is when there is a buildup of T12 states relative to the M+/T12 mix. These T12 and T11 states have relatively and on average high pretime change and hence give movement to the electron. The scaled comparison to large systems shows how it operates. The example which shows this clearly is the interaction of hurricane type weather systems which have similar effects on one another when time is taken out of the analysis.

### Competing Count Models

Observations can be made a gross scale; we have to rely on curvature itself for some of what is observed. Because the count of fpix goes very high in observed curvature, we can expect a continuous count to high levels of compression without repetition or the repetition must be the fractal equivalent of continuing counting fpix alone.

We have fpix as the base count for observed compression and n=n+1 as the quantum count for change. Gravity provides another guide, apparently reflecting 2f(n)\hat{ }(2\hat{ }n) for f(n) and n both equal to one. Then we have to skip up to the photon before our observations are precise again.

### Shifting Base Numbering and the Electron.

In a pure MI universe, the electrons work well as a ct4t12, and the question of structural stability is different.

While a single broken t115 is suggested for the positron in a proton, the idea of a dissolving or merging of the different t15 states in the proton allows for the positron to shift round within the proton staying in contact with the electron (the other half of the t13 within one or more protons).

The problem that arises with the shifting base numbering is that “n” under fpix is 1,3,5,7; so, 7. This would mean if we're using n=7 up to neutron pairing and then moving to n=5 (1,2,3,5) what does that say about the operation of the universe?One solution is that n=3 goes up to neutron bonding and then becomes n=5 (shifting from where the common math is present; 5=5). There is much to say for this solution as it gets rid of some forces (the 2:3 shift in MI) and that seems more consistent with observed force. It also allows the modeling of the electron pairs as two sets of 5.4ct4t12 states.

The alternative is more complex, and the electron (based on weight) becomes nearly full combinations of ct4t13 states so that pairs represent combinations of these. Protons and neutrons in such an event are 2\hat{ }7 combinations instead of 2\hat{ }5 combinations. The problems with precise transitions in terms of existing observations are numerous, but none of them is as significant as those surrounding the information which is “lost” as pretime information states from bonds.

The relativistic changes can be identified from stop frame animation. In the acceleration equation dv/dt, this is the change of position two related matrix over quantum count changes.

As the number of pretime changes between them increases, their quantity within the two matrix decreases. In this way the “change” within the two matrices appears to slow down although the quantum count is the same for both.

In the slide, the “missing” sections reflect the pretime change within the picture being replaced with acceleration of the movement done in a pretime fashion, effectively here being cut out. One could argue that the collapse has been speeded up, but what is really happening is that the pretime change within the collapse has been removed. Gravitational time dilation accomplishes the same thing, the additional compression of ct states with gravity decreases the amount of pretime change which occurs only outside of the compressed states.

Velocity, movement, has to be redefined. Without folding, no movement is possible. Before folding, according to spiral forms reflected by curvature defined by fpix, It's just a chain of bits of information.

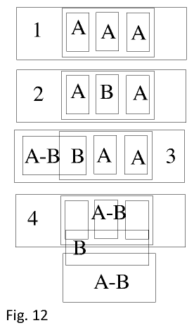

FIG. 12 shows how we can model time and relativistic effects. Time dilation as ct changes increased below B and maintained at a level A at the level of photons in a matrix defined by box 1, all are in equilibrium as the changes are the same at all levels.

In box 2, there is more pretime change B between the two A in equilibrium, experienced as heat.

In box 3 one is accelerating leaving part out of equilibrium with the time dilation being a-B with the B part being the part that is moving relative to the 2 A states.

In box 4 the force of gravity between the top and bottom boxes reflects gravity time dilation, pulling pretime states B which would otherwise change the time of the two a-b blocks into folding. The explosive opposite effect where pretime change B is injected into the blocks of 4 A-B so that they would become A+B is suggested, increasing the pretime change within a system.

To experience time, we have to experience folding (or unfolding) at the level of the photon, although true experience requires that we view it from an exponentially more folded state. Folding has more to do with how time dilation affects the dense volume in the photo. There should be places in space, not necessarily that we can get to, where the object could move faster, but experience less time dilation. Because there is unfolding even at the speed of light. In a gravity well the net unfolding is reduced for lower information states because of ct1 folding in the form of gravity increases removing its effect changing particles.

Shifting Geometries occur from fpix to MI at Neutron Bonding, the gradual nature of the process and spacing defining the resulting fulcrum, the circles defined, is shown. This can involve changes between Two to three dimensional features, particularly between proton and neutron (compression steps), stepped, fractal, gradually, respecting the constraints imposed by fractals, Shifting Base Numbering with Information State Compression: As information states become more compressed, the base numbering system must adapt accordingly, ensuring efficient representation. Overlapping Shifts from Offset to what is more of the same location for fractal states. Overlapping transitions maintain consistency and avoid abrupt changes, ensuring smooth transformations; but also insure inflection points exist which can be targeted to get efficient changes or to time those changes which inflection points repeat as shown by the transitions of f-series curves and fuse length based changes to solutions of fpix where the fuse length is the time between the change in a value of a particular ct1 solution. Coming Together vs. Separation of MI/Fpix and fpix inversions are summed for curvature transitions; coherence vs instability; Compression and Decompression Stages for Fractals in fractally discrete stages; reversible, preserving essential information. These can all be targeted to manipulate the various matrices of interest.

It allows manipulation of the matrix for various purposes like energy manipulation, material manipulation, prediction, etc.; techniques for generating compressed and decompressed fractals within the matrix and it treats time as changes within the matrix and allows modifying transitions between compression states free of relativistic issues.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. A method for modeling and optimizing a dimensional system, the method comprising:
a. generating a fractal-based model of said dimensional system using a fractal equation;
b. identifying one or more Key Fractal Elements (KFE) within said fractal-based model, wherein said KFE include at least one of said fractal equation or fractal results derived from transitions in said fractal equation; and
c. at least one of:
i. predicting the behavior of said dimensional system based on said KFE;
ii. manipulating said dimensional system based on said KFE;
iii. optimizing a performance metric of said dimensional system based on said KFE; or
iv. determining process parameters over a period for said dimensional system and adjusting one or more process parameters of said dimensional system based on said KFE, wherein said parameters are selected from said KFE or features identified by utilizing KFE.

19. The method of claim 18, wherein said fractal equation is fpix, and said KFE are based on at least one of:
a. said fpix equation;
b. an output from the calculation of said fpix equation; and
c. including a mathematical equivalent that obtains the same results as said fpix equation.

20. The method of claim 19, wherein said fpix equation is an iterated equation that gives rise to dimensional pathways resulting in manifestations of reality including at least one of dimension, space, time, force, energy, and matter.

21. The method of claim 20, wherein said dimensional pathways give rise to a plurality of compression states, including at least one first compression state that gives rise to at least one of dimension, space, energy or force, and at least one second compression state that gives rise to matter; and designing a matrix describing force, energy, atomic and molecular structures based on said KFE by:
a. identifying and categorizing dimensional features using said fractal-based model; and
b. modeling at least one of compression or decompression of said KFE states to optimize at least one of force, energy, molecular or atomic interaction.

22. The method of claim 21, wherein said KFE includes at least one alternative to time from the group consisting of:
pretime quantum change, wherein time is treated as a manifestation of said pretime quantum change of at least one lower compression state experienced at the level of a photon; and
fuse length, representing the number of pretime quantum changes inherent in the value of a solution to fpix or based on a numerical value of fpix.

23. The method of claim 20, wherein said system uses at least one of fission or fusion processes, and said KFE are used to increase at least one of modeling, efficiency or control of nuclear reactions along said dimensional pathways.

24. The method of claim 19, wherein said manipulating of said dimensional system is based on targeting KFE transitions which are defined by the mathematical properties of fpix that lead to a change in state, said targeting comprising at least one of:
a. identifying locations of transitions between said KFE;
b. modeling transitions between KFE;
c. targeting transition locations between KFE; or
d. targeting positions of said KFE relative to other KFE along said dimensional pathways.

25. The method of claim 24, wherein said KFE transitions are further characterized by involving at least one of:
a. inflection points or fulcrums within said fractal-based model;
b. being a result of ratios between KFE or between KFE and their reciprocals; or
c. being defined by compression or decompression of matrices of information in the form of ct states built from KFE and the compression of KFE.

26. The method of claim 25, wherein said targeting further comprises targeting at least one balance or imbalance about said inflection points or fulcrums, wherein:
a. said balance is defined by at least one of
i. a level of identity of KFE on either side of said fulcrums;
ii. inflection points,
iii. changes in ratios between KFE,
iv. fulcrums and inflection points separating selected maximum KFE compression on either side of the fulcrum or inflection point under consideration; and
a. said imbalance is defined by a lack of said balance between said KFE.

27. The method of claim 25, wherein said inflection points and fulcrum locations represent discrete quantum changes in state.

28. The method of claim 18, wherein said dimensional system is at least one of an electromagnetic system, a chemical system, a fission system, a fusion system, or a biological system.

29. The method of claim 18, wherein said dimensional system is an energy generation or storage system, and said optimizing a performance metric comprises increasing at least one of energy storage, energy output, type of energy output, efficiency, or stability.

30. The method of claim 18, wherein said dimensional system is a computational system, and said optimizing a performance metric comprises at least one of:
a. converting empirical data into said fractal-based model for analysis;
b. improving the efficiency or accuracy of a machine learning algorithm;
c. evaluating or selecting solutions to processes based on said KFE; or
d. enhancing the predictive capability of an artificial intelligence system.

31. The method of claim 18, wherein said fractal-based model is used for direct physical manipulation of said dimensional system.

32. A method for analyzing a system, the method comprising:
b. acquiring empirical data from said system;
c. converting said data into a fractal-based representation by mapping said data to a plurality of KFE values derived from fpix;
d. identifying patterns in said fractal-based representation to predict system behavior; and
e. generating an output configured to display said predicted behavior or to facilitate control of said system.

33. A system for analyzing a system, the system comprising:
a. a data acquisition module configured to acquire empirical data from said system;
b. a processing unit configured to convert said data into a fractal-based representation by mapping said data to a plurality of KFE values derived from fpix;
c. a modeling engine configured to identify patterns in said fractal-based representation to predict system behavior; and
d. an output module configured to generate an output for displaying said predicted behavior or for controlling said system.

34. The system of claim 33, wherein said modeling engine is further configured to:
a. convert at least some of the data into a common language based on KFE; and
b. optimize the use of the data by performing at least one of the following:
c. comparing, weighting, or associating the data based on the KFE results;
d. limiting selection of answers derived from the data based on answers suggested by the KFE; or
e. correcting selection of answers based on consistency with results suggested by the KFE.

35. The method of claim 21, further comprising iteratively refining said fractal-based model based on empirical data or real-time feedback to do at least one of:
a. optimizing desired performance matrix;
b. identify and filter non-fractal anomalies; or
c. wherein said dimensional system is a database and said optimizing a performance metric comprises accessing said database using fractal-indexed structures based on said fractal-based model.

36. The method of claim 29 further comprising optimizing a performance metric of said energy generation or storage system to do at least one of:
a. converting radiation into electricity using said fractal-based model;
b. quantifying energy based on said fractal-based model; or
c. wherein said system uses at least one of fission or fusion with nuclear reactions, optimizing a performance matrix of efficiency or control of the nuclear reaction along said dimensional pathways based on said fractal-based model.

37. The method of claim 30, wherein said dimensional system is a neural network, and wherein weight adjustment of said neural network is guided by balancing KFE around said inflection points or fulcrums across said fractal-based model.
